(19) United States
(12) Patent Application Publication
(10) Pub. No.: US 2023/0289907 A1
(43) Pub. Date: Sep. 14, 2023

(54) SYSTEM AND METHOD FOR DISTRIBUTING DIGITAL ASSET CONTENT

(71) Applicant: My Planning Place LLC, Cameron Park, CA (US)

(72) Inventors: Silvio REGGIARDO, III, Cameron Park, CA (US); Nicholas L. GUNTHER, Davis, CA (US)

(21) Appl. No.: 18/119,141

(22) Filed: Mar. 8, 2023

Related U.S. Application Data
(60) Provisional application No. 63/372,359, filed on Mar. 8, 2022.

(51) Int. Cl. G06Q 50/18

(52) U.S. Cl. CPC G06Q 50/186

(57) ABSTRACT

A system and method for distributing digital asset content and encrypted data are disclosed. A particular embodiment is configured to: enable a custodian to receive access to digital assets and distribution instructions from a digital asset owner platform; enable the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity; enable the custodian to receive an indication of the death or incapacitation of the digital asset owner from the death reporting entity; enable the custodian to distribute the digital assets to the designated recipient platform in response to receiving the indication of the death or incapacitation of the digital asset owner from the death reporting entity; enable the custodian to receive a first integrity check or authenticated receipt verifying that the designated recipient platform received the distributed digital assets; enable the designated recipient platform to distribute the digital assets to at least one ultimate recipient; enable the designated recipient platform to receive a second integrity check or authenticated receipt verifying that the at least one ultimate recipient received the distributed digital assets; enable the custodian to receive the second integrity check or authenticated receipt verifying that the at least one ultimate recipient received the distributed digital assets; and cause at least a portion of the digital assets to be expunged from data storage in response to receiving the second integrity check or authenticated receipt.

### PRIORITY PATENT APPLICATION

This non-provisional patent application draws priority from U.S. provisional patent application Ser. No. 63/372,359; filed Mar. 8, 2022. This present non-provisional patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure, software, and data as described below and in the drawings that form a part of this document: Copyright 2022-2023, My Planning Place LLC, All Rights Reserved.

### TECHNICAL FIELD

This patent application relates to electronic devices and computer-implemented software systems, according to one embodiment, and more specifically to a system and method for distributing digital asset content and encrypted data.

### BACKGROUND

The Uniform Law Revision Commission's Revised Uniform Fiduciary Access to Digital Assets Act of 2015 (“RUFADAA”) is a set of model digital asset disclosure statutes nearly every state has adopted to the extent relevant for an example embodiment (section references below are to RUFADAA and equivalent state statutes). People tend to store personal, financial and estate planning information in disparate places—some in digital form (often password protected) and some as hard copies in file cabinets or safer places. Absent an urgent need to organize information for a memorial or final messages to loved ones, people tend not to think very far ahead, especially about disturbing or otherwise challenging topics like their mortality. When they die, loved ones or others responsible for dealing with memorials, final arrangements, and estate administration often scramble to find and organize information at an urgent and stressful time. RUFADAA now provides a legal framework for distributing cloud-based digital asset information after the digital asset owner's death. Digital asset distribution services based on RUFADAA have started to emerge. A society that increasingly relies on the internet will readily adopt this approach. RUFADAA can apply to both cloud data storage and locally-stored data; as such, example embodiments also relate to cloud data storage and locally-stored data.

RUFADAA deals with the disclosure and distribution of digital assets, not digital asset title transfers. RUFADAA is a “revised” act because the initial model legislation failed to gain broad state acceptance. RUFADAA achieved that acceptance. The Uniform Law Commission is very unlikely to revise RUFADAA in the foreseeable future, because RUFADAA has created the desired national uniformity in digital asset distribution laws. Amendment would create chaos as states decide whether to adopt proposed amendments. An example embodiment, through the use of modern cryptography, provides a practical technological solution to a technical problem. It is a problem arising from the legal framework governing digital asset content distribution—a problem that will only grow worse as estate planners for digital asset owners increasingly address RUFADAA through disclosure and non-disclosure directions in estate planning documents.

### The Problem

After a digital asset owner dies, the fundamental (non-legal) problem is, who gets to see what digital asset information and when? The correct answer should be: “as the owner intended, and, failing a discernible explicit intent, in accordance with a common-sense method designed to be as fair and equitable as possible given privacy concerns, technological limitations and other practical considerations.” Before RUFADAA, the distribution of a deceased owner's digital asset information was a mess. This is because no legal framework existed to both (a) protect digital asset custodians from improperly disclosing confidential information, and (b) allow deceased owners' executors or other successors to compel the distribution of important information.

RUFADDA solved some but not all of these problems, and it created some new ones. RUFADDA both provides custodians with legal protections and allows owners to give others the right to compel the distribution of digital asset information. However, RUFADDA creates a three-tiered distribution direction hierarchy that can put custodians in a real bind. A deceased owner's estate planning document directions regarding disclosure or non-disclosure can override inconsistent disclosure or non-disclosure directions in a terms-of-service agreement between a custodian and a digital asset owner. Custodians cannot know whether in complying with a terms-of-service agreement's disclosure terms they are complying with RUFADAA, and thus receiving its protections, without first making good faith inquiries regarding whether potentially overriding estate planning documents exist (and, if so, reviewing the relevant content). This provides a practical constraint—a chilling effect—on the prompt distribution of digital asset information that could be most useful for a deceased owner's final arrangements, memorial, and even estate administration.

### SUMMARY

In various example embodiments described herein, a system and method for distributing digital asset content and encrypted data are disclosed. In the various example embodiments described herein, a computer-implemented tool or software application (app) as part of a digital asset distribution system is described to automate and improve the distribution or disclosure of digital assets upon the death of a digital asset owner. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a digital asset distribution system is described for distributing digital asset content within the structure of the Uniform Law Revision Commission's Revised Uniform Fiduciary Access to Digital Assets Act of 2015 (“RUFADAA”), as adopted by various states, using modern cryptography. The described system and method is intended to give digital asset custodians assurance they are distributing deceased digital asset owners' digital asset content in compliance with RUFADAA, without concerns that the digital asset owners' estate planning document or other directions override (and render non-compliant) the digital asset owners' directions to the custodian. The described system and method allow RUFADAA-compliant digital asset content distribution promptly as the owner directed following a digital asset owner's death.

The various example embodiments described herein solve the current problems with digital asset distribution by ensuring that the deceased owner's instructions override any contrary estate planning document directions. This allows custodians to promptly distribute digital asset information as the deceased owner directed. It further allows the distribution under a fully automated, instant and secure process that uses modern cryptography. As a result, custodians receive legal protections for disclosure under RUFADAA. After receiving agreed-upon evidence of the owner's death, designated recipients to whom the owner directed disclosure will promptly receive the owner's digital asset content and related information exactly as the owner directed. Details of the various example embodiments disclosed herein are provided below and in the accompanying drawings.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIG. 2 illustrates an alternative example embodiment of a networked system in which various embodiments may operate;

FIG. 3 illustrates a schematic relating to the information flow between parties for an example embodiment, in which the custodian manages the distribution of the digital asset content;

FIG. 4 illustrates another example embodiment of a networked system in which various embodiments may operate;

FIG. 5 illustrates a processing flow diagram that illustrates an example embodiment of a method as described herein; and

FIG. 6 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for distributing digital asset content and encrypted data are disclosed. In the various example embodiments described herein, a computer-implemented tool or software application (app) as part of a digital asset distribution system is described to automate and improve the distribution or disclosure of digital assets upon the death of a digital asset owner. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a digital asset distribution system is described for distributing digital asset content within the structure of the Uniform Law Revision Commission's Revised Uniform Fiduciary Access to Digital Assets Act of 2015 (“RUFADAA”), as adopted by various states, using modern cryptography. The described system and method is intended to give digital asset custodians assurance they are distributing deceased digital asset owners' digital asset content in compliance with RUFADAA, without concerns that the digital asset owners' estate planning document or other directions override (and render non-compliant) the digital asset owners' directions to the custodian. The described system and method allow RUFADAA-compliant digital asset content distribution promptly as the owner directed following a digital asset owner's death.

### Legal Protections of Good Faith RUFADAA Compliance

RUFADAA both (a) allows a deceased user's (i.e., digital asset owner's) successors to enforce the user's digital asset disclosure and non-disclosure instructions, and (b) gives custodians legal protection for compliance. With respect to that custodian protection, Section 16(f) provides that a custodian is “immune from liability for an act or omission done in good faith in compliance with this [act].” The legal protection custodians receive from RUFADAA compliance is an important aspect of an example embodiment's solution to a practical technological problem. As used herein, the term “deceased user” or “RUFADAA user” refers to a digital asset owner (or someone legally empowered to act on behalf of the digital asset owner) who has died and for whom the release or distribution of the deceased owner's digital assets becomes an issue that needs to be resolved using the technology disclosed herein.

### Certain Critical RUFADAA Definitions

RUFADAA definitions are critical to an example embodiment, which depends on digital asset content disclosure directions a RUFADAA “user” gives to a RUFADAA “custodian” in an “online tool.” Section 2(10) broadly defines a “digital asset” as “an electronic record in which an individual (i.e., owner) has a right or interest . . . .” Section 2(26) defines a “user” as “a person that has an account with a custodian.” Section 2(8) defines a “custodian” as “a person that carries, maintains, processes, receives, or stores a digital asset of a user (i.e., owner).” Section 2(1) defines an “account” as “an arrangement under a terms-of-service agreement in which a custodian carries, maintains, processes, receives, or stores a digital asset of the user (i.e., owner) or provides goods or services to the user (i.e., owner).” Section 2(24) defines a “terms-of-service agreement” as “an agreement that controls the relationship between a user (i.e., owner) and a custodian.”

### Disclosure Priority Under RUFADAA

Under Section 2(24), custodians and digital asset owners may by a terms-of-service agreement generally agree upon digital asset content disclosures or distributions the custodian will make or withhold following a digital asset owner's death. Section 4, however, relegates that agreement's disclosure directions to the bottom of the following hierarchy:
(1) “online tool” directions for disclosure to a “designated recipient”, wherein the digital asset owner may modify or delete the directions at any time,
(2) estate planning document directions regarding disclosure to a “fiduciary,” (e.g., executor or trustee), and
(3) terms-of-service agreement directions.

This means, for example, while the terms-of-service agreement may provide that following the custodian's receipt of predetermined digital asset owner death evidence, the custodian will disclose the digital asset owner's digital asset content to individuals A, B, and C, a conflicting direction in an estate planning document will take precedence. For example, if one of the digital asset owner's estate planning documents requires and limits content disclosure to fiduciary D (e.g., the digital asset owner's named executor), the custodian must and may disclose only to D because the estate planning document disclosure instructions override the inconsistent terms-of-service agreement disclosure directions.

This digital asset distribution problem presents a significant practical problem for custodians. Estate planning document directions are not standard, and the instructions can come in any of several kinds of documents. Under Section 4, “the user (i.e., digital asset owner) may allow or prohibit in a will, trust, power of attorney, or other record, disclosure to a fiduciary of some or all of the digital asset owner's digital assets . . . .” And according to the related Uniform Law Commission's RUFADAA comments, a “fiduciary charged with managing the owner's digital assets must provide a copy of the relevant document to the custodian when requesting access . . . .” A custodian will not know immediately (or even promptly) after a digital asset owner's death whether any such document with disclosure directions exists and if so whether, for example, the document prohibits disclosure entirely or to anyone other than a named fiduciary, or whether the document allows or requires disclosure to a named fiduciary but does not prohibit additional disclosures.

### The RUFADAA “Safe Harbor” Solution

Under RUFADAA, the custodian can qualify for the highest disclosure priority tier (set forth above), thereby avoiding any such overriding estate planning document directions, by using the specified “online tool” procedures with a “designated recipient” (together, the “safe harbor”) as disclosed herein. For example, the custodian can establish a terms-of-service agreement providing for the digital asset owner's disclosure or distribution directions to a “designated recipient” in the online tool as disclosed herein with directions the digital asset owner may modify or delete at any time. Critical to the success of such an online tool and technologically-implemented procedure is understanding the RUFADAA defined terms, “online tool” and “designated recipient.”

### The RUFADAA “Designated Recipient” and “Online Tool”

Under RUFADAA, a “designated recipient” is not simply someone designated to receive information, and an “online tool” is not simply a tool for making online designations. Section 2(9) defines a “Designated recipient” as “a person chosen by a user using an online tool to administer digital assets of the user.” [Emphasis added] Section 2(17) defines a “Person” to include not just a natural person also a “legal entity.” Section 2(16) defines an “Online tool” as “an electronic service provided by a custodian that allows the user, in an agreement distinct from the terms-of-service agreement between the custodian and user, to provide directions for disclosure or nondisclosure of digital assets to a third person.” [Emphasis added] The Uniform Law Commission's Section 2 comments indicate the online tool direction recipient must be a “designated recipient” and that administering digital assets means managing them, stating in relevant part as follows: “An ‘online tool’ is a mechanism by which a user names a [person] to manage the user's digital assets after the occurrence of a future event, such as the user's death . . . [and] [t]he named [person] is referred to as the ‘designated recipient’ in the act . . . .” [Emphasis added] Section 6 requires that the designated recipient must at a minimum have specific assigned tasks, allowing the custodian to limit disclosure to that “sufficient to perform the tasks with which the . . . designated recipient is charged . . . .”

Consequently, in the example set forth above, the A, B, and C group of individuals the digital asset owner selected to receive a digital asset content disclosure does not include a “designated recipient”; because, no such individual will administer (manage) the digital assets in a manner the digital asset owner has directed (whether general management or an assigned task); instead, each individual will simply have access to the information. The digital asset owner's estate planning document disclosure or non-disclosure directions can override the digital asset owner's directions to directly disclose digital asset content to them (even if the digital asset owner did not intent that result).

Custodians should focus on designated recipients, while digital asset owners focus on those who will ultimately receive the digital asset content disclosures. Any reference in this patent application to a “designated recipient” is to that term as used in RUFADAA and therefore means a natural person or entity who administers and distributes digital assets pursuant to a digital asset owner's online tool directions. Any reference in this patent application to an “ultimate recipient” is not a reference to a RUFADAA term, but refers to the person or entity (or people or entities) to whom or which the digital asset owner directs the designated recipient to distribute digital asset content pursuant to the online tool. These ultimate recipients may in turn share the information with others or use it, for example, for the digital asset owner's memorial, final arrangements, death certificate preparation, and estate administration.

Effectively, RUFADAA provides custodians with an essential safe harbor from the risk of distribution directions in potentially difficult-to-find estate planning documents, but at the cost of following a particular technologically-implemented procedure: first, an intermediary qualifying as a “designated recipient” must be designated to perform specific tasks with respect to the digital asset owner's digital assets; and, second, that designated recipient intermediary must receive its instructions with respect to such tasks through an online tool that, under an agreement distinct from the terms-of-service agreement, allows the digital asset owner to modify or delete such instructions at any time.

Custodians want the legal protection that comes with good faith RUFADAA compliance; they do not want to risk the potential liability exposure of improper private information disclosure. RUFADAA does not make custodians strictly liable for digital asset content distributions inconsistent with estate planning document directions, but focuses on whether the custodian acted in “good faith.” Therefore, well-advised custodians will proceed cautiously following a digital asset owner's death. For good faith RUFADAA compliance purposes, custodians will make reasonable efforts to determine whether estate planning documents with RUFADAA disclosure or non-disclosure directions exist. That process will take time and manual review of correspondence if not legal documents. For custodians attempting to comply with RUFADAA in good faith to achieve its protections, the process will render impractical immediate distributions of a deceased digital asset owner's digital asset content for death certificate preparation, final arrangements, or a memorial. Conventional processes involving those prudent custodians seeking to comply with the law will delay estate administration.

### Various Example Embodiments Provide a RUFADAA Compliant On-Line Tool

The various example embodiments disclosed herein provide a system and method for ensuring that a custodian does not impermissibly disclose the digital asset content of a deceased digital asset owner, but makes disclosure as the digital asset owner directed. Furthermore, the various example embodiments disclosed herein provide a system and method that allows for digital asset content distribution in a manner that is secure through end-to-end data encryption, may be fully automated and eliminate manual document review (with its related delay and error potential), and is fully traceable to provide digital proof of performance. The example embodiments of the technologically-implemented system and method disclosed herein advantageously fill these needs and address deficiencies that would otherwise exist, by providing a system and process that allows custodians to know they are disclosing digital asset content to a RUFADAA “designated recipient” in a manner using modern cryptography and that overrides any inconsistent deceased digital asset owner estate planning document disclosure or non-disclosure directions.

Disclosed herein is a system and method for providing access to digital asset content, which can include the following elements or steps: (1) The custodian of cloud-based encrypted digital asset content of a deceased digital asset owner transfers or causes the transfer of a copy of that content to a third party who, (2) takes control of and administers the digital assets by providing a copy of the digital asset content to at least one ultimate recipient (who has received a decryption key) as the digital asset owner directed in an online tool with directions the digital asset owner could modify or delete at any time, and (3) in a manner that uses modern cryptography to provide data security and evidence of data transfers. As described in more detail below, the system and method of an example embodiment may also include distribution of digital asset content at a data storage service rather than custodian stored data.

The example embodiments disclosed herein are unique when compared with other known processes and solutions in that the disclosed embodiments provide a way for a custodian to instantly verify with digital evidence returned from a third party to whom the custodian distributed digital asset content that the third party in turn received, took control of, and distributed the content as the digital asset owner directed in an online tool with directions the digital asset owner could modify or delete at any time; and thus, the custodian has distributed digital asset content to a RUFADAA designated recipient. This elevates the disclosure to the highest tier of RUFADAA's three-tier disclosure hierarchy such that the disclosure directions override any inconsistent disclosure directions the digital asset owner's estate planning documents may have contained. This removes the practical digital asset timing constraints described above; because, custodians will know the directions under the online tool will override inconsistent estate planning document directions. The confirmed digital asset content “hand off” through data hashing and integrity checks will give custodians and/or data storage providers confidence they can delete or expunge data and clear storage earlier than without that evidence. Because the system and method disclosed herein may be fully automated, the disclosed embodiments can expedite the process of distributing digital asset content that may be required or helpful promptly after a digital asset owner's death for death certificate preparation, final arrangements, a memorial, and estate administration. This system and method as disclosed herein improves the functioning and utility of the related computer systems for custodians, data storage providers (e.g., when or how they store and expunge the data), digital asset owners, and digital asset owners' successors in interest. The system and method as disclosed herein also improves the functioning and utility of the overall process of centralizing digital asset content for a time when it is needed after a digital asset owner's death and then promptly distributing the digital asset content as the digital asset owner directed in a secure manner.

The system and method as disclosed herein are different and more efficient than other known processes or solutions. More specifically, the disclosed example embodiments interpose a digital asset custodian and a third party designated recipient between a digital asset owner and the ultimate recipient or recipients of the digital asset content of the digital asset owner. The disclosed example embodiments enable the third party designated recipient to take control of and provide digital asset content access to the ultimate recipient or recipients as a now-deceased digital asset owner has directed, all in a system and process that uses modern cryptography for data security. This third party, identified herein as a “designated recipient,” is enabled by the disclosed example embodiments to carry out a distribution of a digital asset owner's digital assets under the highest priority of the RUFADAA three-tiered distribution hierarchy. The disclosed system and method provide an efficient, legally-complaint, and secure solution; because with the benefits of modern cryptography, the disclosed solution enables a process for distributing digital assets that overrides any inconsistent disclosure or nondisclosure instructions in a deceased digital asset owner's estate planning documents. This allows for immediate and fully automated digital asset content distributions upon the custodian's receipt of digital asset owner death evidence under terms-of-service agreement protocols. Because the custodian knows the online tool directions override any inconsistent estate planning document directions, the custodian knows that in disclosing or distributing digital asset owner information or digital asset content as directed in the online tool, the custodian is releasing private information or assets with RUFADAA-compliant legal protections. The custodian can take advantage of a fully-automated and instant process that will allow those storing the digital asset data to better manage the data and promptly delete or expunge the data and save storage space (having proof of digital transmissions or distributions). The system and process can be fully automated and secure with end-to-end encryption. Digital asset owners will know they can direct the prompt disclosure and distribution of digital asset information, even to multiple people who have no administrative duties with respect to that information or digital assets, such that the information or digital assets can be used for memorials, death certificate preparation, final arrangements, estate administration and/or other matters for which prompt information or digital asset release is desired.

The practical technological solution disclosed in the various example embodiments herein provides a solution to an industry problem that is very unconventional. Estate planners have no control over terms-of-service agreements or online tools. They focus on drafting estate planning document disclosure directions. Data storage providers and custodians storing data profit primarily from serving live customers. They want to comply with disclosure laws but have little incentive to invent creative solutions to help deceased customers' successors. Software engineers focus on software development. They are not RUFADAA experts (to the extent they even know about RUFADAA) and look for the most efficient (usually direct) way to ensure secure data distribution. Digital asset content distribution following a digital asset owner's death is a multi-disciplinary effort involving disciplines with very different focuses and participants with large information gaps due to the information silos in which they work. An example embodiment using modern cryptography in this manner would not be obvious to any of them and is very unconventional in the context of digital asset content disclosure. The solution disclosed in the various example embodiments herein enhances the operation and utility of a system of computers, an array of data storage devices, and a data network used to distribute digital asset content. For that reason, the example embodiments disclosed herein enhance the operation and utility of the entire technical field of centralizing digital asset owners' digital asset content for ultimate distribution after digital asset owner deaths.

In various example embodiments described herein, the digital asset distribution system provides a series of computer-implemented processes to assist in the distribution or transfer of digital assets upon the death of the digital asset owner. Details of the various example embodiments are described in more detail below.

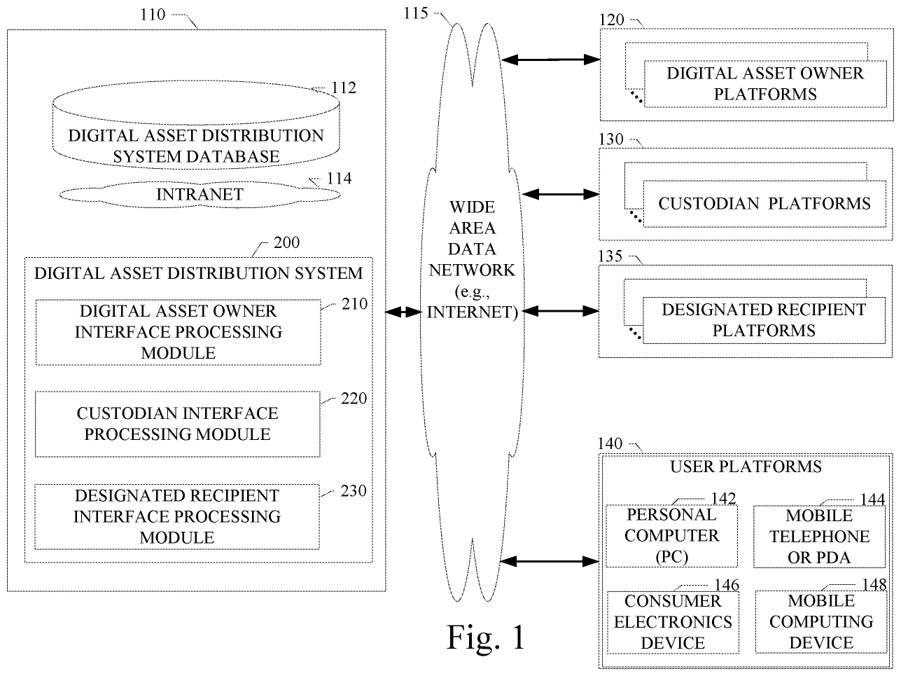

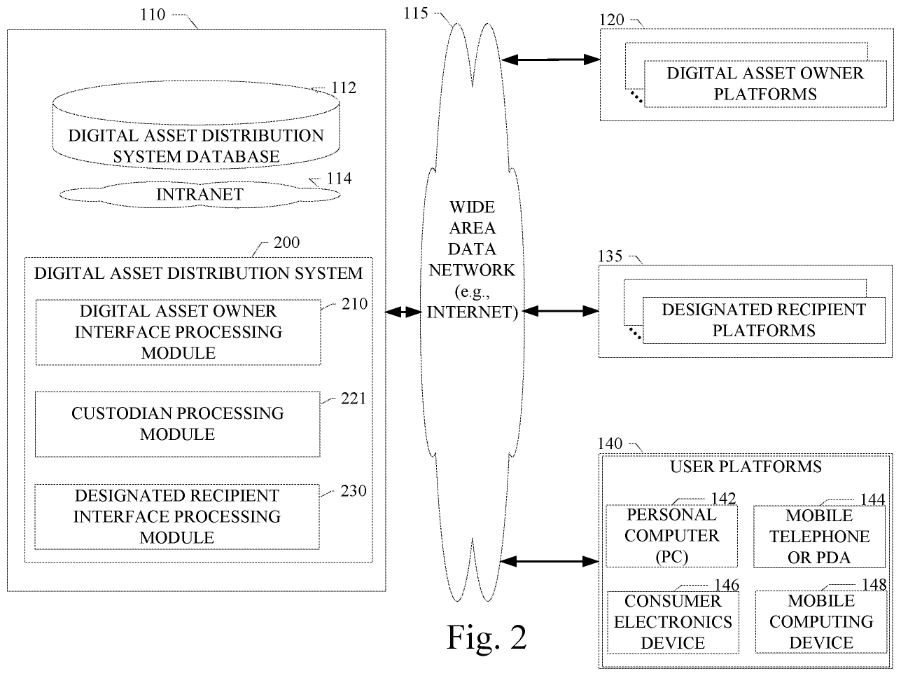

FIG. 1, in an example embodiment, illustrates a system and method for distributing digital asset content and encrypted data in a RUFADAA-compliant manner. In various example embodiments, an application or service, typically provided by or operating on a host site (e.g., a website) 110, is provided to simplify and facilitate the downloading or hosted use of the digital asset distribution system 200 of an example embodiment. Typically, the digital asset distribution system 200 can be hosted by the host site 110 for a networked user at a user platform 140. In the example embodiments disclosed herein, the digital asset distribution system 200 can correspond to the “on-line” tool defined by RUFADAA. The digital asset distribution system 200 can be managed directly by a custodian (e.g., see the example embodiment shown in FIG. 2), or the digital asset distribution system 200 can be managed on behalf of the custodian by a third-party service provider. The details of the digital asset distribution system 200 for an example embodiment are provided below.

Referring again to FIG. 1, the digital asset distribution system 200 can be in network communication with a plurality of digital asset owner platforms 120, custodian platforms 130, and designated recipient platforms 135. Each of these computing platforms can be configured like user platforms 140. The digital asset owner platforms 120 can include user platform computing and/or communication devices, websites, or other network resources at which a digital asset owner (or someone legally empowered to act on behalf of the digital asset owner) can interact with the digital asset distribution system 200, corresponding to the “on-line” tool defined by RUFADAA. The custodian platforms 130 and designated recipient platforms 135 can include user platform computing and/or communication devices, websites, or other network resources at which custodians and designated recipients can interact with the digital asset distribution system 200 as described in more detail below. The digital asset distribution system 200 can be configured to provide data communications (including encrypted data communications) for the user platforms serving as RUFADAA-compliant networked platforms for digital asset owners to empower custodians and designated recipients to distribute digital asset content to individual ultimate recipients in a digital or computer-readable form via the network 115. Additional users of the network ecosystem shown in FIG. 1 operating computing platforms such as user platforms 140 can include the individual ultimate recipients of the digital assets of a deceased digital asset owner as described in more detail below.

The digital asset distribution system 200 may also be configured to provide data communications for the digital asset owner platforms 120 to enable the networked usage, transfer, or downloading of a digital asset owner interface processing module 210. The digital asset owner interface processing module 210 may reside on a digital asset owner platform 120 or may be downloaded to or from the host site 110. In other words, the digital asset owner interface processing module 210 may be used, transferred, or downloaded from/to the host site 110 and the digital asset distribution system 200 therein via the network 115. As such, the digital asset owner interface processing module 210 may be hosted by the host site 110 or locally resident and locally used by a digital asset owner platform 120. Similarly, the digital asset distribution system 200 may also be configured to provide data communications for the custodian platforms 130 to enable the networked usage, transfer, or downloading of a custodian interface processing module 220. The custodian interface processing module 220 may reside on a custodian platform 130 or may be downloaded to or from the host site 110. In other words, the custodian interface processing module 220 may be used, transferred, or downloaded from/to the host site 110 and the digital asset distribution system 200 therein via the network 115. As such, the custodian interface processing module 220 may be hosted by the host site 110 or locally resident and locally used by a custodian platform 130. Moreover, the digital asset distribution system 200 may also be configured to provide data communications for the designated recipient platforms 135 to enable the networked usage, transfer, or downloading of a designated recipient interface processing module 230. The designated recipient interface processing module 230 may reside on a designated recipient platforms 135 or may be downloaded to or from the host site 110. In other words, the designated recipient interface processing module 230 may be used, transferred, or downloaded from/to the host site 110 and the digital asset distribution system 200 therein via the network 115. As such, the designated recipient interface processing module 230 may be hosted by the host site 110 or locally resident and locally used by a designated recipient platform 135.

One or more of the digital asset owner platforms 120, the custodian platforms 130, and the designated recipient platforms 135 can be provided by one or more third party providers operating at various locations in the network ecosystem. It will be apparent to those of ordinary skill in the art that digital asset owner platforms 120, the custodian platforms 130, and the designated recipient platforms 135 can include or be any of a variety of networked third party information providers/consumers or on-line service providers/consumers as described in more detail below. In a particular embodiment, a resource list maintained at the host site 110 can be used as a summary or list of all digital asset owner platforms 120, custodian platforms 130, and designated recipient platforms 135, which users or the host site 110 may visit/access and from which users or the host site 110 can obtain or store digital asset content or related information. The host site 110, digital asset owner platforms 120, custodian platforms 130, designated recipient platforms 135, and user platforms 140 may communicate and transfer data and information in the data network ecosystem shown in FIG. 1 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G), 5th (5G) generation radio access for cellular systems, WLAN, Wireless Router (WR) mesh, and the like. Access technologies such as 2G, 3G, 4G, 5G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The digital asset owner platforms 120, custodian platforms 130, and/or the designated recipient platforms 135 may include any of a variety of providers or consumers of network transportable digital data. The network transportable digital data can be transported in any of a family of file formats and associated mechanisms to enable a host site 110 and a user platform 140 to send/receive digital asset data or related data to/from a digital asset owner platform 120, a custodian platform 130, and/or designated recipient platforms 135 over the network 115. In example embodiments, the file format can a text format, graphic format, image format, video format, audio format, or any related conventional data format. Other file formats and data transport protocols may be used. For example, data formats such as Microsoft™ Access Database Format (MDB), Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein. Moreover, a digital asset owner platform 120, a custodian platform 130, and/or a designated recipient platforms 135 may provide or support a variety of different data sets, computational modules, applications, or the like.

In a particular embodiment, a user platform 140 with one or more client devices enables a user to access data provided by the digital asset distribution system 200 via the host 110 and network 115. Client devices of user platform 140 may include virtually any computing device that is configured to send and receive information over a network, such as network 115. Such client devices may include portable devices 144, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. Moreover, a web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive digital asset content and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the digital asset distribution system 200 for an example embodiment is shown to include a digital asset distribution system database 112. The digital asset distribution system database 112 can be used to retain a variety of information data sets including, but not limited to, digital asset owner information, digital asset content or related information, custodian data, designated recipient data, digital asset distribution analytics, and the like. It will be apparent to those of ordinary skill in the art that the digital asset distribution system database 112 can be locally resident at the host site 110 or remotely located at other server locations or stored in network cloud storage.

Referring again to FIG. 1, host site 110 of an example embodiment is shown to include the digital asset distribution system 200. In an example embodiment, digital asset distribution system 200 can include a digital asset owner interface processing module 210, a custodian interface processing module 220, and a designated recipient interface processing module 230. Each of these modules can be implemented as software components executing within an executable environment of digital asset distribution system 200 operating on host site 110 or user platform 140. Each of these modules of an example embodiment is described in more detail below in connection with the figures provided herein.

Referring still to FIG. 1, the digital asset distribution system 200 can include a digital asset owner interface processing module 210, a custodian interface processing module 220, and a designated recipient interface processing module 230. The digital asset owner interface processing module 210 can facilitate communication and the transfer of data, digital assets, and documents between a user at a digital asset owner platform 120 and the host site 110. The custodian interface processing module 220 can facilitate communication and the transfer of data, digital assets, and documents between a user at a custodian platform 130 and the host site 110. The designated recipient interface processing module 230 can facilitate communication and the transfer of data, digital assets, and documents between a user at a designated recipient 135 and the host site 110. The digital asset owner interface processing module 210, custodian interface processing module 220, and designated recipient interface processing module 230 can be configured to perform the processing as described in more detail below. The digital asset owner interface processing module 210 can be resident at the host site 110, resident on a digital asset owner platform 120, or partially resident on a plurality of user platforms 140. Similarly, the custodian interface processing module 220 can be resident at the host site 110, resident on a custodian platform 130, or partially resident on a plurality of user platforms 140. Moreover, the designated recipient interface processing module 230 can be resident at the host site 110, resident on a designated recipient platform 135, or partially resident on a plurality of user platforms 140. The digital asset distribution system 200 be configured to provide data communications for the digital asset owner platforms 120, the custodian platforms 130, and the designated recipient platforms 135 to enable the networked usage, distribution, disclosure, transfer, or downloading of digital assets, information, requests, images, documents, and related data to facilitate the authorized distribution of an owner's digital assets. The components and processes for the authorized distribution of an owner's digital assets as embodied in the digital asset owner interface processing module 210, the custodian interface processing module 220, and the designated recipient interface processing module 230 are described in more detail below.

An example embodiment provides a system and method that allows a digital asset owner at a digital asset owner platform 120 to securely transfer digital asset content, related data, and documents between their computer or computer systems and the host site 110, which can be a third-party's cloud-based computing cluster. This secure data transfer capability can be implemented and controlled by the digital asset owner interface processing module 210. This secure data transfer capability enables the digital asset owner or custodian to share specific digital asset content of the owner with approved designated recipients. This data transfer may take place via the data network 115 using protocols such as HTTP, FTP, SMTP, etc., whereby information, that may be encrypted using SSL/TLS, is exchanged in a variety of formats (including, but not limited to, XML and JSON formats). The digital asset owner or custodian can share the digital asset content via the host site 110.

Referring now to FIG. 2, an example embodiment provides a system and method wherein the digital asset distribution system 200 can be managed directly by a custodian at the host site 110. In this configuration, the custodian processing module 221 manages the interactions between the digital asset owner platforms 120, the designated recipient platforms 135, and the individual ultimate recipients of the digital assets operating user platforms 140. In other respects, the alternative example embodiment shown in FIG. 2 operates in a manner similar to the embodiment shown in FIG. 1 and described in more detail below.

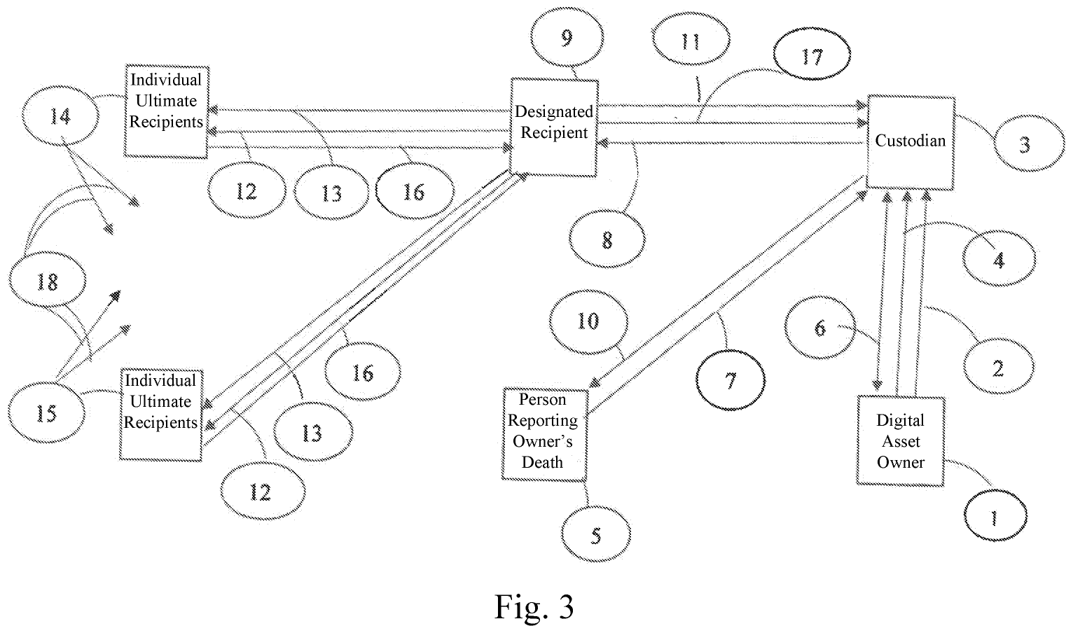

Referring now to FIG. 3, an example embodiment provides a system and method that allows digital asset owners to use the digital asset owner interface processing module 210 via a digital asset owner platform 120 to initiate a process whereby the digital assets of the owner can be arranged, configured, and authorized for RUFADAA-compliant distribution after the death of the digital asset owner. Referring again to FIG. 3, the schematic shows an information or data processing flow for an example embodiment, in which a custodian 3 at a custodian platform 130 using custodian interface processing module 220 (or alternatively using custodian processing module 221) may store or otherwise assume control of the distribution of the digital asset content of a digital asset owner 1. In operation 2 shown in FIG. 3, the digital asset owner 1 using the digital asset owner interface processing module 210 at a digital asset owner platform 120 can transfer digital asset content (or digital asset content access data) and distribution instructions or otherwise provide access to the digital asset content to/for the custodian 3, after authenticating the identity of the custodian 3. The digital asset owner 1 at operation 4 can further provide authenticated or authenticating credentials or other information empowering the custodian 3 to act on behalf of the digital asset owner 1 with regard to the disclosure or distribution of the owner's 1 digital assets upon the death of the digital asset owner 1. In operation 6 shown in FIG. 3, the digital asset owner 1 can further provide an authenticated agreement (e.g., a terms-of-service agreement) or other authenticated information to the custodian 3 advising the custodian 3 of the name(s) or other identifying information, which identifies the designated recipient(s) 9 to whom/which the custodian 3 will provide the disclosure or distribution of the owner's 1 digital assets upon the death of the digital asset owner 1. The authenticated agreement (e.g., a terms-of-service agreement) or other authenticated information provided to the custodian 3 by the digital asset owner 1 in operation 6 can also inform the custodian 3 of the name(s) or other identifying information, which identifies a death reporting individual or entity 5 who/which has the authority to report the death or incapacity of the digital asset owner 1 under protocols specified in the authenticated agreement. The custodian 3 can send an acknowledgement back to the digital asset owner 1 to indicate receipt of the digital asset content, distribution instructions, and authenticated agreement.

In operation 7 shown in FIG. 3, an individual or entity 5 who/which has the authority to report the death or incapacity of the digital asset owner 1 reports the death or incapacity of the digital asset owner 1 to the custodian 3. Upon receipt of the authenticated death or incapacity notice, the custodian 3 can segregate or assemble the owner's 1 digital asset content as directed by the digital asset owner 1. In operation 8 shown in FIG. 3, the custodian 3 can then distribute or disclose the owner's 1 designated digital asset content as directed by the digital asset owner 1 with a decryption key or keys to the designated recipient(s) 9. In operation 10 shown in FIG. 3, after the custodian 3 distributes or discloses the owner's 1 digital asset content to the designated recipient(s) 9, the custodian 3 can provide to the individual or entity 5 who/which has the authority to report the death or incapacity of the digital asset owner 1 information indicative of integrity check evidence that verifies that the digital asset content was transferred to the designated recipient(s) 9. Similarly, at operation 11 shown in FIG. 3, the designated recipient(s) 9 can provide the custodian 3 with a first integrity check or authenticated receipt proving and verifying the transfer and receipt of the digital asset content and decryption key by the designated recipient(s) 9. In operations 12 and 13 shown in FIG. 3 and in response to receipt of the digital asset content and decryption key, the designated recipient 9 can allocate and then distribute the allocated owner's 1 digital asset content and a corresponding decryption key(s) for the particular distributed digital asset content to individual ultimate recipients 14 and 15. In operation 16 shown in FIG. 3 and in response to receipt of the digital asset content and decryption key(s), the individual ultimate recipients 14 and 15 can provide second integrity checks or receipts to the designated recipient(s) 9, which provides integrity check evidence to prove these distributions of the digital assets by the designated recipient(s) 9 to the individual ultimate recipients 14 and 15. Subsequently, in operation 17, the designated recipient(s) 9 can provide the second integrity check evidence to the custodian 3 to prove the distribution of the digital assets by the designated recipient(s) 9 to the individual ultimate recipients 14 and 15. The ultimate recipients 14 and 15 may further distribute the digital assets or related information 18 or use the assets or information, for example, for final arrangements and estate administration. Given the received integrity checks and/or receipts from the parties in the transactions described above, data storage providers, custodians, and designated recipients who stored digital assets or related information may delete or expunge the deceased digital asset owners' data as soon as reasonably possible to free up data storage space.

Reference is made to the background of the embodiments discussed above. In the example embodiments disclosed herein, the digital asset owner can transfer digital asset content to a third party who can store the digital assets on cloud servers. That third party may be a RUFADAA custodian of a data storage provider. This transfer process can occur in any number of ways, from manual input to artificial intelligence applications. In accordance with an authenticated agreement (e.g., a terms-of-service agreement) between the digital asset owner and custodian, through the use of the online tool disclosed herein with directions the digital asset owner may modify or delete at any time, the digital asset owner can direct the custodian to disclose or distribute, following report of the digital asset owner's death, the digital asset content to a third party (which will likely be an entity and can even be affiliated with the custodian) for disclosure or distribution to at least one ultimate recipient as the digital asset owner has directed. If the digital asset owner wants certain digital asset content (such as emails) not to be disclosed to family or friends, the digital asset owner can direct that information to be stored with a third party who will hold the designated digital assets for a reasonable time in a “digital asset cemetery” where the designated digital assets would be available in the event required by subpoena or court order (e.g., for litigation) and ultimately deleted.

In an alternative example embodiment, the RUFADAA custodian does not need to store the digital assets of the digital asset owner. A RUFADAA “custodian” must have or provide an account (including a terms-of-service agreement) with or for a digital asset owner; but, according to Section 2(8), the defined “custodian” need not store digital asset content. A custodian includes one who “carries, maintains, processes, receives, or stores a digital asset of a user.” Due to data storage cost and security concerns, some custodians may want existing storage providers (generally large companies with a broad range of services) to store digital assets and related data for a digital asset owner. One solution is for data storage providers to provide digital asset owners with a view (e.g., a portal) into the library of a digital asset owners' digital assets. To ensure privacy and a high degree of security, that digital asset data can be encrypted and then decrypted on demand for the digital asset owner (and ultimately those the digital asset owner wants to see the digital asset content after the digital asset owner's death) through that view.

A custodian may hold (or process as described above) a single type of digital asset (such as photos) or several kinds of digital assets (e.g., photos, financial information, estate planning documents, emails, and other personal information) that will be distributed to the designated recipient for disclosure to a single individual or more than one individual, who must also receive decryption keys. Hashing the data can be used in a particular example embodiment to validate data deliveries and track data processing. Other types of data validation techniques can be similarly used. Data validation can be used to validate that the custodian distributed the digital asset data the custodian received from the digital asset owner to the designated recipient, and validate that the designated recipient in turn distributed the data as directed to the individual ultimate recipients. This data validation can be performed with hashing and integrity checks in an example embodiment. It may not be necessary to use a more complicated process, such as blockchain technology. However, the distributed ledger benefits of blockchain may be a substitute for a trusted third party. This implementation may provide evidence that every digital asset the owner provided to the custodian has in fact been distributed. Hashing would provide evidence that information sent and received was the same (including evidence that all of the information the digital asset owner sent to the custodian ultimately was distributed, and not just be a data count check). In other embodiments, digital signature technology can be used to validate data integrity. For particularly sensitive or valuable information, blockchain may make more sense.

A custodian that does not store but processes digital asset content can provide the data storage provider with a concatenation layer, or a concatenation artificial intelligence application programming interface (API), the data storage provider codes. On a digital asset owner's death, the data for all of the digital asset owner's digital assets can be concatenated (combined sequentially) into a single stream, with pre-specified dividers indicating the portions the digital asset owner wants the designated recipient to send to different ultimate recipients along with an integrity check (hash index) the custodian can use to verify that the custodian received accurately the data the service provider sent. The custodian receives the stream and the integrity check from the data storage provider, stores the content, and computes an integrity check of the content to verify it is the same as the integrity check the data service provider sent the custodian. This confirms that the custodian received accurately what the data service provider sent (if there is an inaccuracy the data stream can be retransmitted and corrected). The custodian then divides the content, computes integrity checks of the pieces, and sends the pieces and the integrity checks to the designated recipient for distribution to the ultimate recipients as the digital asset owner directed using the online tool disclosed herein. The ultimate recipients return the integrity checks that confirm they received accurately what the custodian sent to the designated recipient and the designated recipient in turn sent to the ultimate recipients. In another example embodiment, the designated recipient may perform some of the above-referenced steps of the custodian.

Data storage providers and custodians who store data want to delete or expunge deceased digital asset owners' data as soon as reasonably possible to free up storage space, but want to have proof that they made an appropriate and authorized digital asset content handoff. For example, if such a digital asset owner's data is sought by subpoena or court order, data storage providers and custodians can prove they distributed the data they had and can prove the identity of the ultimate recipient(s) of that data. An example embodiment also allows for the use of a place to store data for a reasonable time for such orders or subpoenas in a sort of “digital asset cemetery”. The missing piece the custodian or data storage provider needs in order to delete or expunge a digital asset is a demonstration that everything the custodian distributed to the designated recipient, which was then distributed to the ultimate recipient(s), equals in the aggregate what the custodian received from the data storage provider. Homomorphic hashing, a cryptographic technique, can provide this missing piece. Under homomorphic hashing, the integrity check of what the custodian received from the data storage provider can be determined easily from the integrity checks of what the designated recipient sent out to the ultimate recipient(s). In this manner, it can be demonstrated with a very high degree of confidence that the custodian sent out everything the custodian received from the data storage provider, and to the correct ultimate recipient(s). Homomorphic hashing allows for the manipulation of data without actual access to the data and therefore allows the process described above to work with end-to-end encryption. This process shows that the ultimate recipients received accurately what the data service provider sent, all with the security of modern cryptography (including without limitation integrity and authenticity checks and with other standard data confirmation processes data storage providers can show they transferred correctly to the custodian all data they received from the right digital asset owner). Those who stored a deceased digital asset owner's data can more confidently delete or expunge the data with the knowledge that they have accurately delivered the data as directed. They can delete or expunge large data files and retain very small integrity check files of approximately the same length for each digital asset owner.

In terms of information flow, the digital asset owner provides the digital asset information to the custodian, who may store the digital asset information in the network cloud. When the custodian receives notice of the digital asset owner's death as per the terms of a service agreement (whether the digital asset owner is actually deceased), the custodian distributes the digital asset content to the designated recipient (which can be an entity related to the custodian or not, because RUFADAA simply refers to a designated recipient as a third person who administers the digital assets). The designated recipient in turn distributes the digital asset content as directed in the online tool as disclosed herein. This all happens instantly and securely with encryption and conditional instructions. The information distribution can be tracked with modern cryptography. Using the system and method disclosed herein, the designated recipient takes control of the digital asset content and under any reasonable definition administers and distributes the digital assets as required for “designated recipient” status, thereby enabling digital asset distribution according to the top RUFADAA tier and overriding any estate planning document instructions that might exist.

Another example embodiment can include the management of “shallow” digital asset information and more sensitive information. For example, the digital asset owner can provide the custodian with actions or information necessary to promptly obtain a death certificate (so the family does not have to search files at a stressful time) and a memorial (e.g., pictures, song lists, messages, disposition directions, etc.). It would not take much evidence of digital asset owner death to break that information loose. For digital asset information that is more sensitive or valuable, more proof would be required (e.g., a death certificate or some other reliable evidence, or death certification information in a digital form). This two-tiered or multi-tiered approach can be similarly implemented using the computer-implemented processes described above.

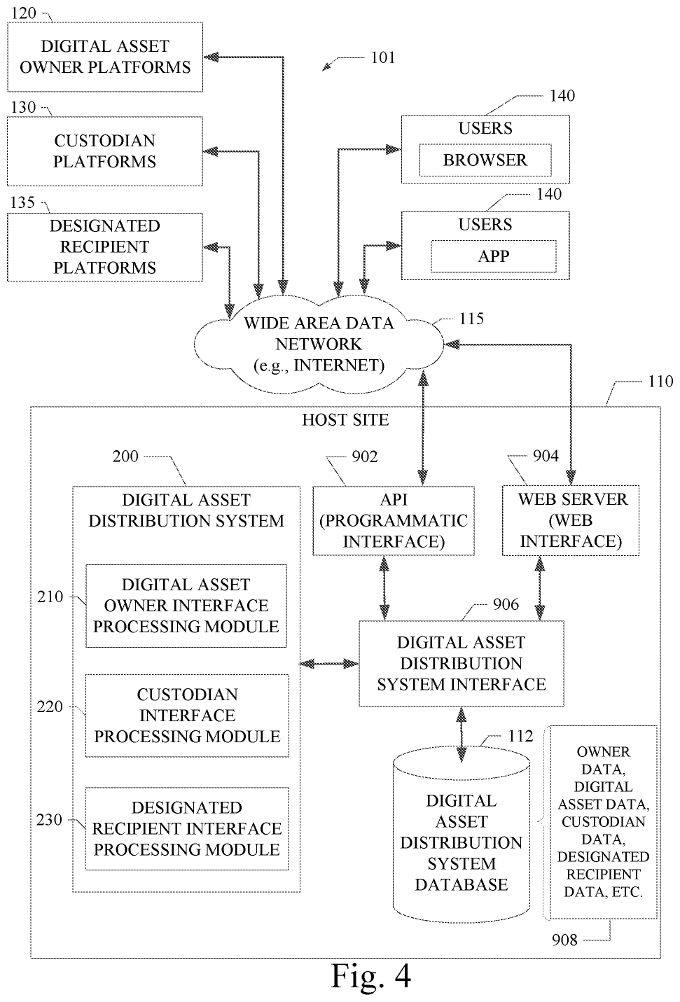

Referring now to FIG. 4, another example embodiment 101 of a networked system in which various embodiments may operate is illustrated. In the embodiment illustrated, the host site 110 is shown to include the digital asset distribution system 200. The digital asset distribution system 200 is shown to include the digital asset owner interface processing module 210, the custodian interface processing module 220, and the designated recipient interface processing module 230 as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the digital asset distribution system 200 either directly or via an interface 906. The digital asset distribution system 200 may be configured to access a data storage device 112 either directly or via the interface 906.

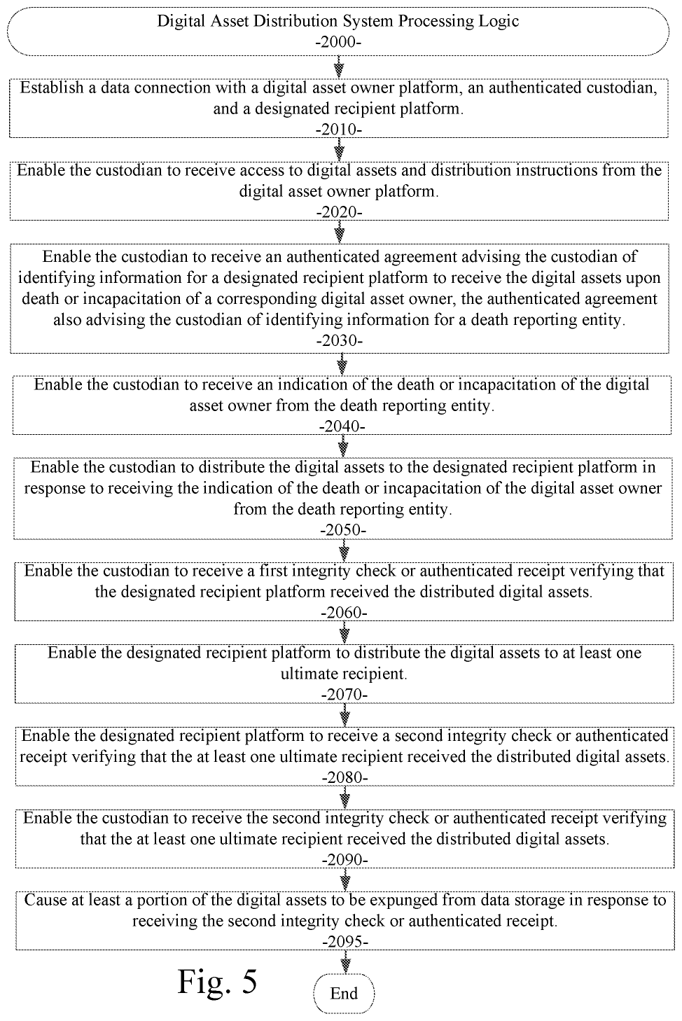

Referring now to FIG. 5, a processing flow diagram illustrates an example embodiment of a method implemented by the digital asset distribution system 200 as described herein. The method 2000 of an example embodiment can be configured to: establish a data connection with a digital asset owner platform, an authenticated custodian, and a designated recipient platform (processing block 2010); enable the custodian to receive access to digital assets and distribution instructions from the digital asset owner platform (processing block 2020); enable the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity (processing block 2030); enable the custodian to receive an indication of the death or incapacitation of the digital asset owner from the death reporting entity (processing block 2040); enable the custodian to distribute the digital assets to the designated recipient platform in response to receiving the indication of the death or incapacitation of the digital asset owner from the death reporting entity (processing block 2050); enable the custodian to receive a first integrity check or authenticated receipt verifying that the designated recipient platform received the distributed digital assets (processing block 2060); enable the designated recipient platform to distribute the digital assets to at least one ultimate recipient (processing block 2070); enable the designated recipient platform to receive a second integrity check or authenticated receipt verifying that the at least one ultimate recipient received the distributed digital assets (processing block 2080); enable the custodian to receive the second integrity check or authenticated receipt verifying that the at least one ultimate recipient received the distributed digital assets (processing block 2090); and cause at least a portion of the digital assets to be expunged from data storage in response to receiving the second integrity check or authenticated receipt (processing block 2095).

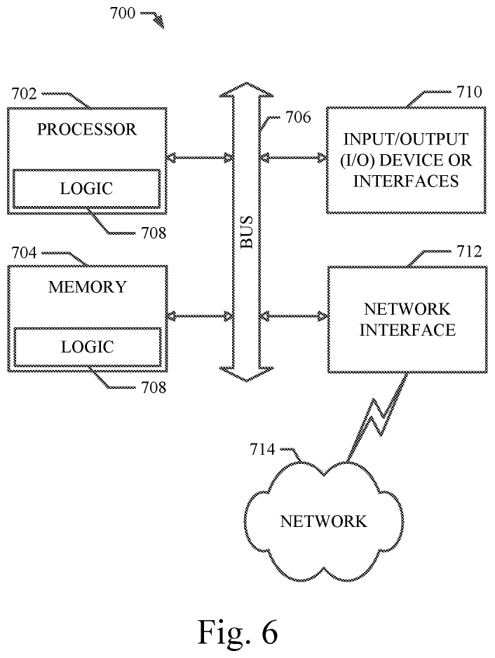

FIG. 6 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

In the various example embodiments disclosed herein, a system and method for distributing a deceased digital asset owner's digital asset content, using modern cryptography, to a designated recipient pursuant to an online tool the digital asset owner could modify or delate at any time is thereby described. In the various example embodiments described herein, a computer-implemented tool or software application (app) as part of a digital asset distribution system is described to automate and improve the collection, storage, distribution, and verification of digital assets between parties according to the direction of the digital asset owner. As such, the various embodiments as described herein are necessarily rooted in computer processing, data storage, and network technology and serve to improve these technologies when applied in the manner as presently claimed. In particular, the various embodiments described herein improve the use of data storage technology and data network technology in the context of digital asset storage and distribution via electronic means. The various example embodiments as described herein serve to improve data processing, data storage, and network communication technologies when applied in the manner as presently claimed by enabling a deceased digital asset owner to designate the distribution of digital assets according to the highest RUFADAA tier through mandatory disclosure of all content under the online tool as disclosed herein, which is beneficial for custodians because—
1) They can ignore contrary estate planning document disclosure instructions (so no manual document review).
2) They can have a fully automated content distribution process under the online tool.
3) They will have legal cover for information releases in compliance with RUFADAA.
4) They can delete data from servers or move it to a new account after the handoff.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
a network interface, in data communication with the data processor, for communication on a data network; and
a digital asset distribution system, executable by the data processor, to:
establish, by use of the data processor and the data network, a data connection with a digital asset owner platform;
establish, by use of the data processor and the data network, a data connection between the digital asset owner platform and an authenticated custodian;
establish, by use of a data processor and a data network, a data connection with a designated recipient platform;
enable, by use of the data processor, the custodian to receive access to digital assets and distribution instructions from the digital asset owner platform;
enable, by use of the data processor, the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity;
enable, by use of the data processor, the custodian to receive an indication of the death or incapacitation of the digital asset owner from the death reporting entity;
enable, by use of the data processor, the custodian to distribute the digital assets to the designated recipient platform in response to receiving the indication of the death or incapacitation of the digital asset owner from the death reporting entity;
enable, by use of the data processor, the custodian to receive a first integrity check or authenticated receipt verifying that the designated recipient platform received the distributed digital assets;
enable, by use of the data processor, the designated recipient platform to distribute the digital assets to at least one ultimate recipient;
enable, by use of the data processor, the designated recipient platform to receive a second integrity check or authenticated receipt verifying that the at least one ultimate recipient received the distributed digital assets;
enable, by use of the data processor, the custodian to receive the second integrity check or authenticated receipt verifying that the at least one ultimate recipient received the distributed digital assets; and
cause, by use of the data processor, at least a portion of the digital assets to be expunged from data storage in response to receiving the second integrity check or authenticated receipt.

2. The system of claim 1 being further configured to cryptographically encrypt, by use of the data processor, the digital assets.

3. The system of claim 1 being further configured to enable, by use of the data processor, the designated recipient platform to receive a decryption key.

4. The system of claim 1 wherein the digital assets include information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

5. The system of claim 1 being further configured to enable, by use of the data processor, the digital asset owner to provide authenticated or authenticating credentials or other information empowering the custodian to act on behalf of the digital asset owner with regard to the disclosure or distribution of the digital assets upon death of the digital asset owner.

6. The system of claim 1 wherein the first integrity check or authenticated receipt includes hashing information corresponding to the digital assets.

7. The system of claim 1 wherein the digital assets are stored using blockchain technology.

8. A computer-implemented method comprising:
establishing, by use of a data processor and a data network, a data connection with a digital asset owner platform;
establishing, by use of the data processor and the data network, a data connection between the digital asset owner platform and an authenticated custodian;
establishing, by use of a data processor and a data network, a data connection with a designated recipient platform;
enabling, by use of the data processor, the custodian to receive access to digital assets and distribution instructions from the digital asset owner platform;
enabling, by use of the data processor, the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity;
enabling, by use of the data processor, the custodian to receive an indication of the death or incapacitation of the digital asset owner from the death reporting entity;
enabling, by use of the data processor, the custodian to distribute the digital assets to the designated recipient platform in response to receiving the indication of the death or incapacitation of the digital asset owner from the death reporting entity;
enabling, by use of the data processor, the custodian to receive a first integrity check or authenticated receipt verifying that the designated recipient platform received the distributed digital assets;
enabling, by use of the data processor, the designated recipient platform to distribute the digital assets to at least one ultimate recipient;
enabling, by use of the data processor, the designated recipient platform to receive a second integrity check or authenticated receipt verifying that the at least one ultimate recipient received the distributed digital assets;
enabling, by use of the data processor, the custodian to receive the second integrity check or authenticated receipt verifying that the at least one ultimate recipient received the distributed digital assets; and
causing, by use of the data processor, at least a portion of the digital assets to be expunged from data storage in response to receiving the second integrity check or authenticated receipt.

9. The method of claim 8 including cryptographically encrypting, by use of the data processor, the digital assets.

10. The method of claim 8 including enabling, by use of the data processor, the designated recipient platform to receive a decryption key.

11. The method of claim 8 wherein the digital assets include information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

12. The method of claim 8 including enabling, by use of the data processor, the digital asset owner to provide authenticated or authenticating credentials or other information empowering the custodian to act on behalf of the digital asset owner with regard to the disclosure or distribution of the digital assets upon death of the digital asset owner.

13. The method of claim 8 wherein the first integrity check or authenticated receipt includes hashing information corresponding to the digital assets.

14. The method of claim 8 wherein the digital assets are stored using blockchain technology.

15. A non-transitory machine-useable storage medium embodying instructions which, when executed by a machine, cause the machine to:
establish, by use of a data processor and a data network, a data connection with a digital asset owner platform;
establish, by use of the data processor and the data network, a data connection between the digital asset owner platform and an authenticated custodian;
establish, by use of a data processor and a data network, a data connection with a designated recipient platform;
enable, by use of the data processor, the custodian to receive access to digital assets and distribution instructions from the digital asset owner platform;
enable, by use of the data processor, the custodian to receive an authenticated agreement advising the custodian of identifying information for a designated recipient platform to receive the digital assets upon death or incapacitation of a corresponding digital asset owner, the authenticated agreement also advising the custodian of identifying information for a death reporting entity;
enable, by use of the data processor, the custodian to receive an indication of the death or incapacitation of the digital asset owner from the death reporting entity;
enable, by use of the data processor, the custodian to distribute the digital assets to the designated recipient platform in response to receiving the indication of the death or incapacitation of the digital asset owner from the death reporting entity;
enable, by use of the data processor, the custodian to receive a first integrity check or authenticated receipt verifying that the designated recipient platform received the distributed digital assets;
enable, by use of the data processor, the designated recipient platform to distribute the digital assets to at least one ultimate recipient;
enable, by use of the data processor, the designated recipient platform to receive a second integrity check or authenticated receipt verifying that the at least one ultimate recipient received the distributed digital assets;
enable, by use of the data processor, the custodian to receive the second integrity check or authenticated receipt verifying that the at least one ultimate recipient received the distributed digital assets; and
cause, by use of the data processor, at least a portion of the digital assets to be expunged from data storage in response to receiving the second integrity check or authenticated receipt.

16. The non-transitory machine-useable storage medium of claim 15 being further configured to cryptographically encrypt, by use of the data processor, the digital assets.

17. The non-transitory machine-useable storage medium of claim 15 being further configured to enable, by use of the data processor, the designated recipient platform to receive a decryption key.

18. The non-transitory machine-useable storage medium of claim 15 wherein the digital assets include information relating to estate planning documents for trust or estate administration, financial assets, liabilities, taxes, insurance, death certificate, final arrangements, obituary, memorial service assets, photographs, song lists, emails, contact lists, last statements, or wishes to family or friends.

19. The non-transitory machine-useable storage medium of claim 15 being further configured to enable, by use of the data processor, the digital asset owner to provide authenticated or authenticating credentials or other information empowering the custodian to act on behalf of the digital asset owner with regard to the disclosure or distribution of the digital assets upon death of the digital asset owner.

20. The non-transitory machine-useable storage medium of claim 15 wherein the first integrity check or authenticated receipt includes hashing information corresponding to the digital assets.
